(19) United States
(12) Patent Application Publication
(10) Pub. No.: US 2014/0040735 A1
(43) Pub. Date: Feb. 6, 2014

(54) METHOD FOR PROVIDING VOICE GUIDANCE FUNCTION AND AN ELECTRONIC DEVICE THEREOF

(71) Applicant: Samsung Electronics Co., Ltd., Gyeonggi-do (KR)

(72) Inventor: Hoon-Soub Jung, Gyeongsangbuk-do (KR)

(73) Assignee: Samsung Electronics Co., Ltd., Gyeonggi-do (KR)

(21) Appl. No.: 13/960,568

(22) Filed: Aug. 6, 2013

(30) Foreign Application Priority Data
Aug. 6, 2012 (KR) 10-2012-0085812

(51) Int. Cl. G06F 3/16

(52) U.S. Cl. CPC G06F 3/167
USPC 715/708

(57) ABSTRACT

Embodiments of the present disclosure include a voice guidance function for visually challenged people in an electronic device, and more particularly, an apparatus and method for inducing a touch input location of a user who uses contents data in the electronic device and for changing a data analysis (or data reading) direction and area. A method provides a voice guidance function in an electronic device. The method includes outputting a reproduction screen of contents, determining a data analysis area by confirming an arrangement of data constituting an output screen, and inducing a user input to the determined data analysis area, wherein the data arrangement comprises at least one of a line, a line start point, a line end point, a sentence start point, a sentence end point, and a page of the output screen.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Aug. 6, 2012 and assigned Serial No. 10-2012-0085812, the entire disclosure of which is hereby incorporated by reference.

### TECHNICAL FIELD

The present disclosure is for providing a voice guidance function for visually challenged people in an electronic device. More particularly, the present disclosure relates to an apparatus and method for guiding a touch input location for a user who uses contents data in the electronic device.

### BACKGROUND

Recently, portable terminals have become necessities of modern life for people of all ages. Thus, service providers and terminal manufacturers are competitively developing differentiated products (or services).

For example, the portable terminal has developed into a multimedia device capable of providing various services such as phonebooks, games, short messages, e-mails, wake-up calls, MPEG-1 Audio Layer 3 (MP3) players, scheduling, multimedia messages, and wireless Internet.

In spite of extension of a service area which uses the electronic device, a service has been provided primarily for average people, and thus physically challenged people are excluded from a consumer group for a mobile communication service. Further, since it is difficult for visually challenged people to identify basic key buttons or the like required in the electronic device, there are more difficulties in the use of the mobile communication service.

Accordingly, a Braille-based device for visually challenged people is provided to solve a problem occurring when the visually challenged people control the device.

In general, the visually challenged people use hands to read Braille and thus can recognize a word, a sentence, etc., indicated by the Braille.

However, since the electronic device cannot provide the Braille for output data, there is a problem in that the visually challenged people cannot read the content of data (i.e., text data) which is output to the electronic device.

Of course, the electronic device can output text data by converting the text data into audio data through a Text-To-Speech (TTS) function, but in this method, a user cannot confirm a location of the data converted into the audio data.

Therefore, in order to solve the aforementioned problem, there is a need for an apparatus and method of an electronic device for reproducing contents by using a voice guidance function.

### SUMMARY

To address the above-discussed deficiencies of the prior art, it is a primary object to provide an apparatus and method for providing a voice guidance function of data of contents reproduced in an electronic device.

Another aspect of the present disclosure is to provide an apparatus and method for changing an area of data provided by using a voice guidance function according to a pen pressure of a user in an electronic device.

Another aspect of the present disclosure is to provide an apparatus and method for inducing a change of a touch input point by using a voice guidance function in an electronic device.

Another aspect of the present disclosure is to provide an apparatus and method for regulating an output speed of a voice guidance function according to a touch input of a user in an electronic device.

Another aspect of the present disclosure is to provide an apparatus and method for providing indicator information indicating a state of an electronic device by using a voice guidance function in the electronic device.

In accordance with a first aspect of the present disclosure, a method for providing a voice guidance function in an electronic device is provided. The method includes outputting a reproduction screen of contents, determining a data analysis area by confirming an arrangement of data constituting an output screen, and inducing a user input to the determined data analysis area. The data arrangement includes at least one of a line, a line start point, a line end point, a sentence start point, a sentence end point, and a page of the output screen.

In accordance with a second aspect of the present disclosure, an apparatus for providing a voice guidance function in an electronic device is provided. The apparatus includes at least one processor, a memory, and at least one program stored in the memory and configured to be executable by the at least one processor, wherein the program includes an instruction for outputting a reproduction screen of contents, for determining a data analysis area by confirming an arrangement of data constituting an output screen, and for inducing a user input to the determined data analysis area. The data arrangement includes at least one of a line, a line start point, a line end point, a sentence start point, a sentence end point, and a page of the output screen.

In accordance with a third aspect of the present disclosure, a computer-readable storage medium, if performed by an electronic apparatus, for storing one or more programs is provided. The program includes outputting a reproduction screen of contents, determining a data analysis area by confirming an arrangement of data constituting an output screen, and inducing a user input to the determined data analysis area. The data arrangement includes at least one of a line, a line start point, a line end point, a sentence start point, a sentence end point, and a page of the output screen.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of an electronic device for providing a voice guidance function according to an exemplary embodiment of the present disclosure;

FIG. 2 illustrates a flowchart of a process of reproducing contents by using a voice guidance function in an electronic device according to an exemplary embodiment of the present disclosure;

FIG. 3 illustrates a flowchart of a process of reproducing text data by using a voice guidance function in an electronic device according to an exemplary embodiment of the present disclosure;

FIG. 4 illustrates a flowchart of a process of providing motion information to a guide area in an electronic device according to an exemplary embodiment of the present disclosure;

FIG. 5 illustrates a flowchart of a process of changing a guide area on the basis of a pen pressure in an electronic device according to an exemplary embodiment of the present disclosure;

FIG. 6 illustrates a flowchart of a process for changing an output speed of an audio signal in an electronic device according to an exemplary embodiment of the present disclosure;

FIG. 7 illustrates a flowchart of a process of providing indicator information as an audio signal in an electronic device according to an exemplary embodiment of the present disclosure;

FIGS. 8A-K illustrate a screen for reproducing contents by using a voice guidance function in an electronic device according to an exemplary embodiment of the present disclosure;

FIGS. 9A-C illustrate a screen for providing movement information for a touch input of a user in an electronic device according to an exemplary embodiment of the present disclosure;

FIGS. 10A-B illustrate a screen for changing a guide area in an electronic device according to an exemplary embodiment of the present disclosure;

FIGS. 11A-C illustrate a screen for providing indicator information in an electronic device according to an exemplary embodiment of the present disclosure;

FIG. 12A illustrates a flowchart of a process of providing a voice guidance function in an electronic device according to an exemplary embodiment of the present disclosure; and

FIG. 12B illustrates a flowchart of a process for performing a voice guidance function related to an electronic device according to an exemplary embodiment of the present disclosure.

### DETAILED DESCRIPTION

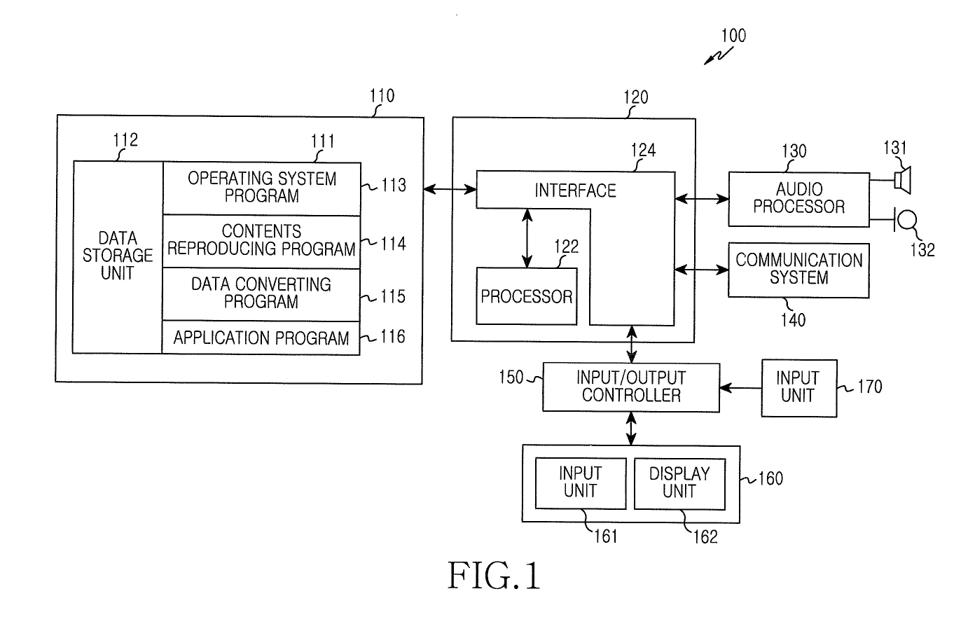

FIGS. 1 through 12B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Exemplary embodiments of the present disclosure will be described herein below with reference to the accompanying drawings. In the following description, well-known functions or constructions are not described in detail since they would obscure the disclosure in unnecessary detail.

The present disclosure described hereinafter relates to an apparatus and method for changing a data analysis direction and area for contents in an electronic device and for inducing a touch input location of a user to the data analysis area.

The data analysis area refers to an area of data selected to be transmitted as an audio signal among data constituting contents, and may be the same meaning as a guide area in the following description. Herein, the contents may be a text-based electronic book (e-book) file, an incoming or outgoing message, a browser screen, etc.

In addition, the electronic device may be a portable electronic device. Further, the electronic device may be a portable terminal, a mobile phone, a media player, a tablet computer, a handheld computer, or a Personal Digital Assistant (PDA). Furthermore, the electronic device may be any portable electronic device including a device which combines two or more functions among these devices.

FIG. 1 illustrates a structure of an electronic device for providing a voice guidance function according to an exemplary embodiment of the present disclosure.

Referring to FIG. 1, an electronic device 100 includes a memory 110, a processor unit 120, an audio processor 130, a communication system 140, an input/output controller 150, a touch screen 160, and an input unit 170. Herein, the memory 110 and the communication system 140 may be plural in number.

Each component will be described below.

The memory 110 includes a program storage unit 111 for storing a program for controlling an operation of the electronic device 100 and a data storage unit 112 for storing data generated during the program is executed. For example, the data storage unit 112 stores a variety of rewritable data, such as phonebook entries, outgoing messages, incoming messages, etc.

In addition, the program storage unit 111 includes an operating system program 113, a contents reproducing program 114, a data converting program 115, and at least one application program 116. Herein, the program included in the program storage unit 111 is a set of instructions, and can be expressed as an instruction set.

The operating system program 113 includes various software components for controlling a general system operation. The control of the general system operation implies, for example, memory management and control, storage hardware (device) control and management, power control and management, etc. The operating system program 113 also performs a function of facilitating communication between various hardware (device) and program component (module).

The contents reproducing program 114 includes at least one software component for reproducing contents to be provided by using a voice guidance function. That is, the contents reproducing program 114 may reproduce text-based contents (e.g., an e-book file, an incoming or outgoing message, and a browser screen) and may output the contents to a screen.

In this case, the contents reproducing program 114 converts data of the reproduced contents (i.e., text data constituting contents, image data included in the contents) into an audio signal via the data converting program 115, and outputs the converted audio signal. For example, the contents reproducing program 114 may output a text included in the contents as an audio signal, and may output a file name of an image for the contents as an audio signal.

In addition, the contents reproducing program 114 analyzes a content reproducing screen to determine a guide area which is an area capable of selecting data of contents output to the screen. In this case, the contents reproducing program 114 may determine the guide area for each word, sentence, paragraph, and page. Further, the contents reproducing program 114 may configure guide areas each of which has a different data analysis direction. That is, the contents reproducing program 114 determines a guide area (i.e., a first guide area) for supporting a data analysis direction which is the same as a touch movement direction of the user and a guide area (i.e., a second guide area) for supporting a data analysis direction which is opposite to the touch movement direction of the user.

In addition, the contents reproducing program 114 regulates an audio signal output speed according to a touch input movement speed of the user. That is, if a touch input for the contents reproducing screen moves fast, the contents reproducing program 114 outputs an audio signal converted from text data (corresponding to a location through which a touch movement has passed) at a high speed.

In addition, the contents reproducing program 114 may output direction information for inducing a user's touch input movement to a specific location. That is, the contents reproducing program 114 may output direction information, which moves a touch point currently input by the user to a bookmark point, a start point of a line, etc., as an audio signal.

In addition, the contents reproducing program 114 may sense the user's touch input to output indicator information as an audio signal.

In addition, the data converting program 115 converts data to be provided by the contents reproducing program 114 by using the voice guidance function into an audio signal.

For example, the data converting program 115 converts data which has undergone the user's touch input into an audio signal.

In addition, the data converting program 115 converts information of an indicator icon for which the user's touch input is sensed into an audio signal.

The application program 116 includes a software component for at least one application program installed in the electronic device 100.

The processor unit 120 includes at least one processor 122 and an interface 124. Herein, the processor 122 and the interface 124 may be integrated as at least one integrated circuit or may be implemented as separate components.

The interface 124 takes a role of a memory interface for controlling an access of the processor 122 and the memory 110.

In addition, the interface 124 takes a role of a peripheral device interface for controlling a connection of the processor 122 and an input/output peripheral device of the electronic device 100.

The processor 122 provides a voice guidance function for contents reproduced by the electronic device by using at least one software program. In this case, the processor 122 executes at least one program stored in the memory 110 to provide the voice guidance function corresponding to the program. For example, the processor 122 may include a voice guidance processor for providing the voice guidance function. That is, the voice guidance function of the electronic device 100 may be performed in software such as a program stored in the memory 110 or in hardware such as the voice guidance processor.

The audio processor 130 provides an audio interface between the user and the electronic device 100 via a speaker 131 and a microphone 132. For example, the audio processor 130 may output an audio signal provided by the contents reproducing program via the speaker 131. According to the present disclosure, the audio processor 130 outputs the audio signal converted by the data converting program 115. The communication system 140 performs a communication function for voice communication and data communication of the electronic device 100. In this case, the communication system may be divided into a plurality of communication sub-modules for supporting different communication networks. For example, although not limited thereto, the communication network includes a Global System for Mobile Communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, a Wireless Local Area Network (WLAN), a Bluetooth network, Near Field Communication (NFC), etc.

The input/output controller 150 provides an interface between an input/output device (e.g., the touch screen 160, the input unit 170, etc.) and an interface.

The touch screen 160 is an input/output device for performing information input and information output, and includes a touch input unit 161 and a display unit 162.

The touch input unit 161 provides touch information sensed via a touch panel to the processor unit 120 via the input/output controller 150. In this case, the touch input unit 161 provides the touch information to the processor unit 120 by changing the information in an instruction format such as touch_down, touch_move, and touch_up. According to the present disclosure, the touch input unit 161 senses an input of a user who selects data to be converted into an audio signal in a contents reproducing screen and provides the sensed input to the processor unit 120.

The display unit 162 displays status information of the electronic device 100, a character input by the user, a moving picture, a still picture, etc. For example, the display unit 162 outputs the contents reproducing screen.

The input unit 170 provides input data generated by a selection of the user to the processor unit 120 via the input/output controller 150. For one example, the input unit 170 includes only control buttons for the control of the electronic device 100. For another example, the input unit 170 may consist of a key pad for receiving a data input from the user.

Although not shown, the electronic device 100 may further include components for providing an additional function such as a camera module for image or video capture, a broadcast receiving module for broadcast reception, a digital sound source reproducing module such as an MP3 module, a near field communication module for near field communication, a proximity sensor for proximity sensing, etc., and a software element for operating the components.

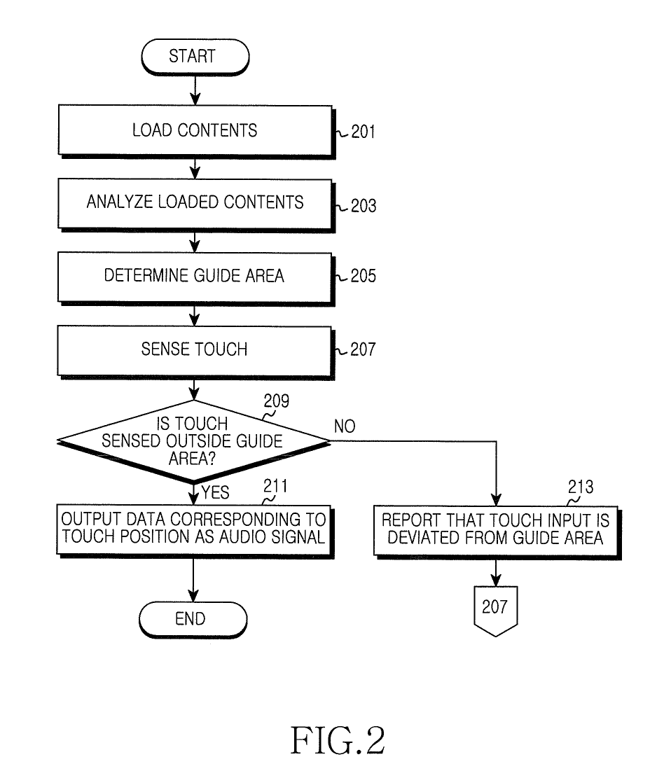

FIG. 2 illustrates a flowchart of a process of reproducing contents by using a voice guidance function in an electronic device according to an exemplary embodiment of the present disclosure.

Referring to FIG. 2, according to the exemplary embodiment of the present disclosure, the electronic device outputs the content of e-book contents to a screen, and provides a voice guidance function for providing the content of the contents as an audio signal at the request of a user.

Herein, an output screen of the e-book contents consists of a plurality of pieces of data. In this case, the data implies text data, image data, etc., output to the screen when the contents are reproduced. The electronic device of the present disclosure provides a function for outputting data constituting the contents by converting the data into an audio signal.

In order to perform such an operation, the electronic device loads and reproduces a contents file in step 201, and analyzes the content of the reproduced contents in step 203. Herein, the process of step 203 is performed to confirm an arrangement pattern of data output to the screen of the electronic device. In this case, the electronic device may analyze a line, a start point and end point of a sentence, a page, etc., of the output screen.

For example, the electronic device may analyze a code value of a text stored in a frame buffer when the contents are reproduced, and thus may confirm an arrangement pattern of the output data. That is, the electronic device may confirm a start and end of a page by using a first code value and last code value of the frame buffer.

In addition, the electronic device may confirm a previous line and a next line by reading a new line code (e.g., “\n” “\r”) of the frame buffer.

Although it is described above that the electronic device confirms the arrangement pattern by using the code value stored in the frame buffer, the electronic device of the present disclosure may confirm the data arrangement pattern by using a plurality of well-known techniques for analyzing data to be output.

In step 205, the electronic device determines a guide area for data output to the screen when the contents are reproduced. Herein, the guide area is an area for selecting data contents output to the screen of the electronic device. The electronic device may sense a touch movement within the guide area, and may output data corresponding to a movement location as an audio signal. That is, a user of the electronic device may input data in the guide area by using hands as if the user reads a Braille book. The guide area may be determined on the basis of a line, sentence, and paragraph of the output screen according to the present disclosure.

In step 207, the electronic device senses a touch input of the user who uses a finger, a stylus pen, an electronic pen, etc. In step 209, the electronic device determines whether a touch input occurs outside the guide area.

If it is determined in step 209 that the touch input occurs inside the guide area, proceeding to step 211, the electronic device outputs data corresponding to a touch location as an audio signal. In this case, if it is determined that the touch input is sensed on text data, the electronic device may convert the text data into audio data and then provide the converted data to the user.

In addition, if it is determined that the touch input is sensed on image data, the electronic device may convert information on the image data (e.g., a file name, brief information of the image data included in meta data) into audio data and then provide the converted data to the user.

Meanwhile, if it is determined in step 209 that the touch input occurs outside the guide area, proceeding to step 213, the electronic device may provide the user with an alarm to report that the touch input of the user is deviated from the guide area. This is to allow the user to recognize that the touch input occurs outside the guide area since an output screen of the electronic device cannot express Braille.

That is, the user of the electronic device selects data in the output screen by using an electronic pen or hands of the user as if the user reads the Braille book, and the electronic device may provide information on the data selected by the user or information on a location of the touch input as a voice guidance.

After providing the voice guidance for the touch input of the user as described above, the procedure of FIG. 2 ends.

Although e-book contents are reproduced by using the voice guidance function in FIG. 2 for example, the present disclosure is not limited thereto. Thus, the electronic device of the present disclosure can reproduce all text-based contents (e.g., an incoming or outgoing message, a memo, a browser screen, etc.) by using the voice guidance function in addition to the e-book contents. If the electronic device outputs the browser screen, then HTML Tag information may be analyzed to confirm an arrangement pattern of data to be output.

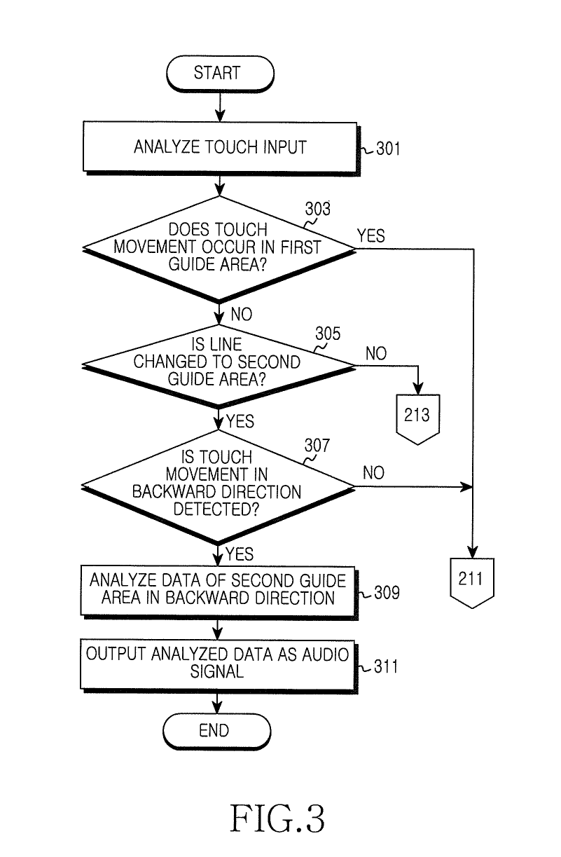

FIG. 3 illustrates a flowchart of a process of reproducing text data by using a voice guidance function in an electronic device according to an exemplary embodiment of the present disclosure.

Referring to FIG. 3, it is assumed that the electronic device outputs text data consisting of a plurality of lines.

In addition, the electronic device defines lines as respective guide areas, and each guide area is determined to have a different data analysis direction according to a crossing order. For example, an odd guide area enables data analysis in a forward direction, and an even guide area enables data analysis in a backward direction. Herein, the data analysis in the forward direction is for analyzing data in the same direction as a touch movement direction when a touch moves in the forward direction, and the data analysis in the backward direction is for analyzing data in a direction opposite to the touch movement direction when the touch moves in the backward direction. That is, data is analyzed in one direction even if the user moves the touch in different directions.

In step S301, the electronic device analyzes a touch input performed by the user. In step S303, the electronic device determines whether a touch movement occurs in a first guide area. Herein, the occurrence of the touch movement in the first guide area may be a situation in which the user moves a touch to sequentially output text data of the guide area as an audio signal.

If it is determined in step 303 that the touch movement occurs inside the first guide area, returning to step 211 of FIG. 2, the electronic device outputs data corresponding to the touch location as an audio signal.

Otherwise, if it is determined in step 303 that the touch movement does not occur inside the first guide area (i.e., if the touch movement is deviated from the first guide area), proceeding to step 305, the electronic device determines whether the touch input of the user moves to a second guide area.

If it is determined in step 305 that the touch input of the user moves to another place instead of the second guide area, returning to step 213 of FIG. 2, the electronic device may provide the user with an alarm for reporting that the touch input of the user is deviated from the guide area.

Otherwise, if it is determined in step 305 that the touch input of the user moves to the second guide area, proceeding to step 307, the electronic device detects a touch movement in the backward direction. If the touch movement in the backward direction is not detected in step 307, the procedure returns to step 211 of FIG. 2. Otherwise, proceeding to step 309, the electronic device analyzes data of the second guide area in the backward direction. Then, in step 311, the electronic device outputs the analyzed data as an audio signal.

In general, in a reproduction screen of contents, text data is input in a unilateral direction (i.e., from the left to the right, or from the right to the left).

Therefore, the user may need to move the touch input in an input direction of text data so that the content of an audio signal is normally output.

If the user changes a line of the text data, the user may need to move the touch input to a first position of the changed line. In this case, it is difficult for a visually challenged user to move the touch input to a new line.

Accordingly, the user who uses the electronic device of the present disclosure may move the touch input from an end point of a line to an end point of a next line, and thereafter may perform the touch input in the backward direction in the moved line.

In this case, even if the touch input is performed in the backward direction, the electronic device may analyze data in the forward direction and normally output the content of the audio signal. That is, even if the user moves the touch input in the backward direction in the changed line, the electronic device outputs data by analyzing the data in the forward direction.

Thereafter, the procedure of FIG. 3 ends.

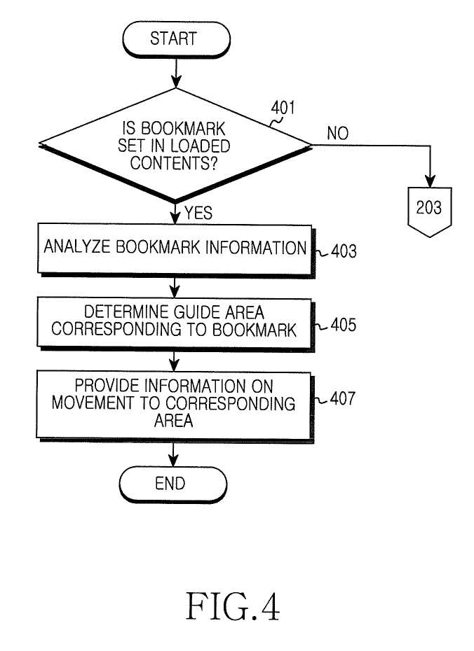

FIG. 4 illustrates a flowchart of a process of providing motion information to a guide area in an electronic device according to an exemplary embodiment of the present disclosure.

Referring to FIG. 4, the electronic device induces a touch input of a user to a location at which a bookmark is set when reproducing contents. In this case, the location at which the bookmark is set may be not only a bookmark page but also a specific paragraph, sentence, word, etc.

The electronic device for performing, the aforementioned operation determines whether the bookmark is set in loaded contents in step 401.

If it is determined in step 401 that the bookmark is not set, the process of step 203 of FIG. 2 is performed. That is, the electronic device performs a contents analysis process to determine a guide area for the loaded contents.

Otherwise, if it is determined in step 401 that the bookmark is set, proceeding to step 403, the electronic device analyzes bookmark information. Thereafter, in step 405, the electronic device determines a guide area corresponding to the bookmark. In this case, the electronic device may analyze a frame buffer, HTML Tag, etc., as described above to determine the guide area.

In step 407, the electronic device provides information on a movement to a corresponding area. In this case, the electronic device may confirm a reproducing point of contents by analyzing the bookmark information, and may provide direction information as an audio signal so that the user can touch the confirmed point.

For example, the electronic device may confirm a path to the reproducing point of the contents on the basis of a current touch point of the user, and thereafter may provide the path information as an audio signal so that the touch point of the user can be changed to the up, down, left, right, etc.

In addition, if a partial vibration is possible for a touch panel, the electronic device may generate a vibration for only a shortest path part to the reproducing point of the contents.

Thereafter, the procedure of FIG. 4 ends.

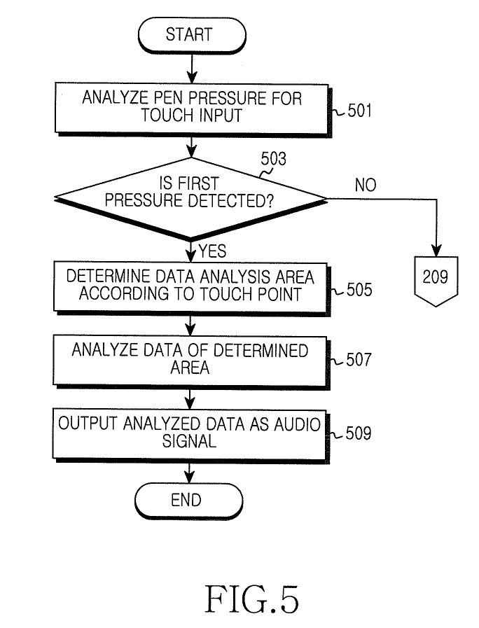

FIG. 5 illustrates a flowchart of a process of changing a guide area on the basis of a pen pressure in an electronic device according to an exemplary embodiment of the present disclosure.

Referring to FIG. 5, the electronic device analyzes a pen pressure with respect to a touch input in step 501, and thereafter detects a first pressure corresponding to a pre-set threshold in step 503.

If the first pressure is not detected in step 503, the process of step 209 of FIG. 2 is performed. That is, the electronic device determines whether a touch input is sensed in a guide area to output data corresponding to the touch input as an audio signal.

Otherwise, if the first pressure is detected in step 503, proceeding to step 505, the electronic device determines a data analysis area by extending the data analysis area according to the touch point.

Herein, the data analysis area refers to a range of data to be converted into an audio signal. For example, a user of the electronic device may convert only data for a touch input point into an audio signal by using a pen pressure less than a threshold. In addition, the electronic device may extend the data analysis area to a sentence or paragraph according to the touch input point by using a pen pressure greater than or equal to the threshold, and thereafter may convert data of the extended data analysis area into an audio signal. In this case, the electronic device may define the pen pressure in a plurality of levels so that the data analysis area can be extended for each word, sentence, paragraph, and page according to the pen pressure.

After determining the data analysis area according to the pen pressure as described above, the electronic device analyzes data of the determined area in step 507, and then outputs the analyzed data by converting the data into an audio signal in step 509.

The pen pressure of the user in FIG. 5 is only one example of a user input type, and thus the electronic device of the present disclosure may determine a different data analysis area according to a user input type.

Thereafter, the procedure of FIG. 5 ends.

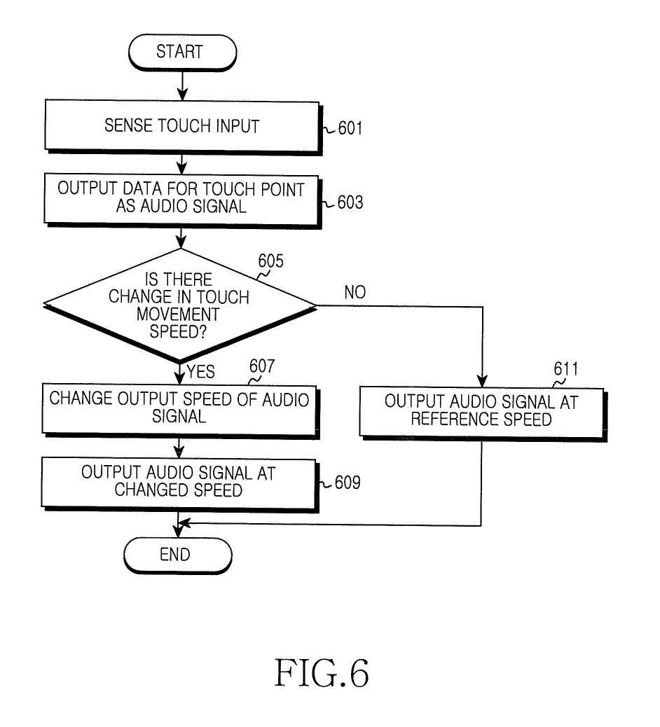

FIG. 6 illustrates a flowchart of a process for changing an output speed of an audio signal in an electronic device according to an exemplary embodiment of the present disclosure.

Referring to FIG. 6, the electronic device outputs data of contents by converting the data into an audio signal when a user moves a touch input as described above. In addition, the electronic device can change an output speed of data converted into an audio signal on the basis of a touch input movement speed according to the present disclosure.

The electronic device for performing the aforementioned operation senses a touch input in step 601, and then outputs data for a point at which the touch input occurs as an audio signal in step 603. That is, the data corresponding to the point at which the touch input of the user occurs in loaded contents is converted into the audio signal and is then output at a pre-set output speed. In this case, if it is confirmed that the user performs the touch input, the electronic device outputs a location, which changes as a user input location changes, as an audio signal.

In step 605, the electronic device determines whether there is a change in a user's touch movement speed for the contents.

If it is determined in step 605 that there is no change in the user's touch movement speed for the contents, proceeding to step 611, the electronic device outputs an audio signal at a reference speed (i.e., a pre-set speed).

Otherwise, if it is determined in step 605 that there is a change in the user's touch movement speed for the contents, proceeding to step 607, the electronic device changes an audio signal output speed according to the touch movement speed. In step 609, the electronic device outputs the audio signal at the changed speed.

That is, if the user's touch movement speed for the contents becomes fast, the electronic device changes the output speed of the audio signal to a high speed, and if the user's touch movement speed for the contents becomes slow, the electronic device changes the output speed of the audio signal to a low speed.

Thereafter, the procedure of FIG. 6 ends.

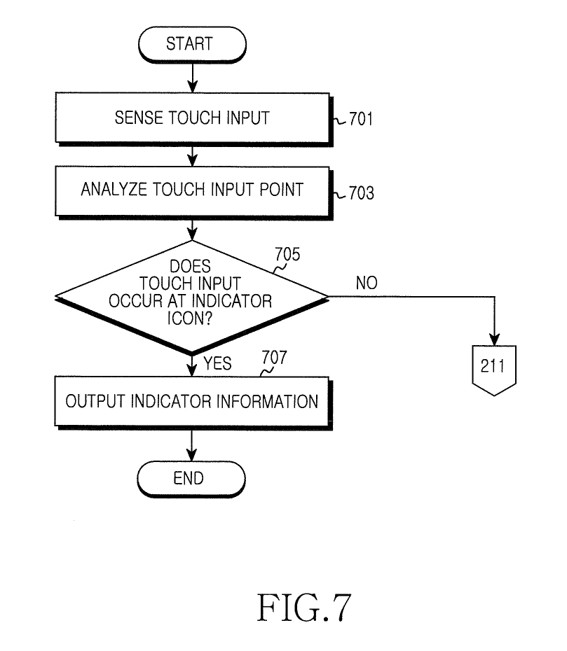

FIG. 7 illustrates a flowchart of a process of providing indicator information as an audio signal in an electronic device according to an exemplary embodiment of the present disclosure.

Referring to FIG. 7, the electronic device outputs data of contents by converting the contents into an audio signal according to movement of a user's touch input, as descried above. In addition, the electronic device outputs information of an indicator corresponding to a touch input by converting the information of an indicator into an audio signal according to the present disclosure. Herein, the indicator information refers to information which is output by iconifying status information of the electronic device. For example, the indicator information may be a reception rate (indicated by an antenna), battery residual quantity, time, alarm, etc., included in a status bar.

In addition, the indicator information is information for an object which is output to the electronic device, and may be an icon of a pre-installed application.

The electronic device for performing the aforementioned operation senses a touch input of a user in step 701, and then analyzes a touch input point in step 703.

In step 705, the electronic device determines whether a touch input occurs in an indicator icon. Herein, as described above, the indicator icon is information indicating a status of the electronic device, and may be an icon of a reception rate, battery residual quantity, a time alarm, etc., or may be an icon of a pre-installed application.

If it is determined in step 705 that the touch input does not occur in the indicator icon, returning, to step 211 of FIG. 2, the electronic device outputs data corresponding to a touch point by converting it into an audio signal.

If it is determined in step 705 that the touch input occurs in the indicator icon, proceeding to step 707, the electronic device outputs indicator information by converting the indicator information into an audio signal. In this case, the electronic device outputs the electronic device's reception rate, battery residual quantity, time, alarm setting information, and information on an application for which the touch input occurs as an audio signal according to the touch input of the user.

Thereafter, the procedure of FIG. 7 ends.

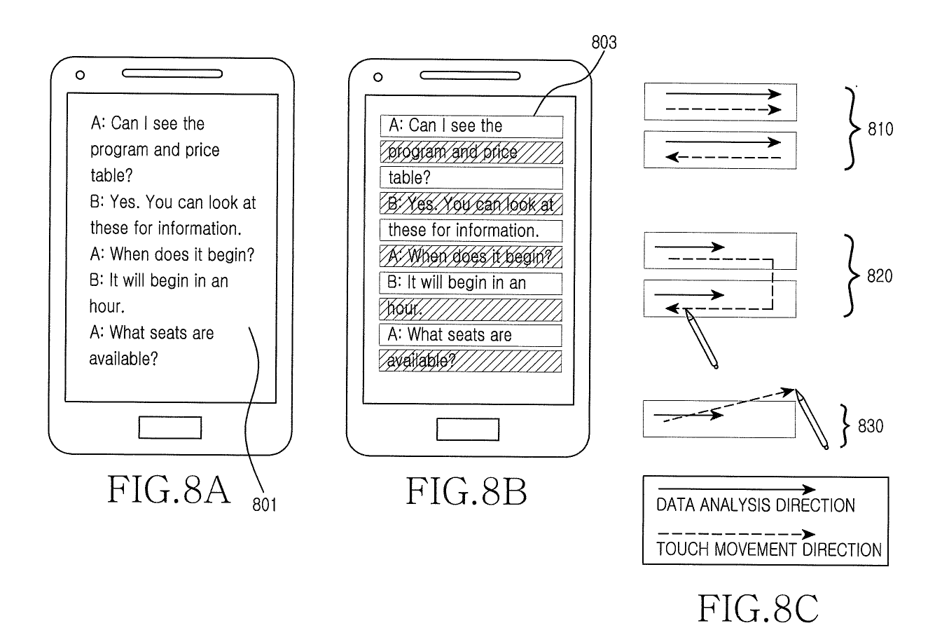

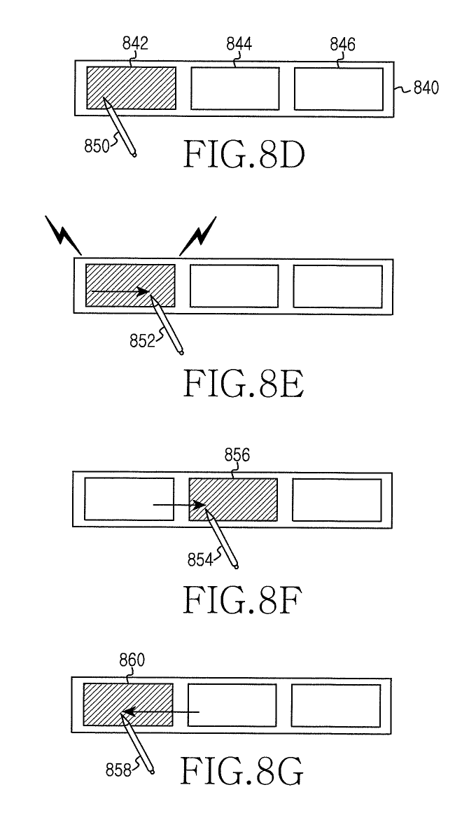

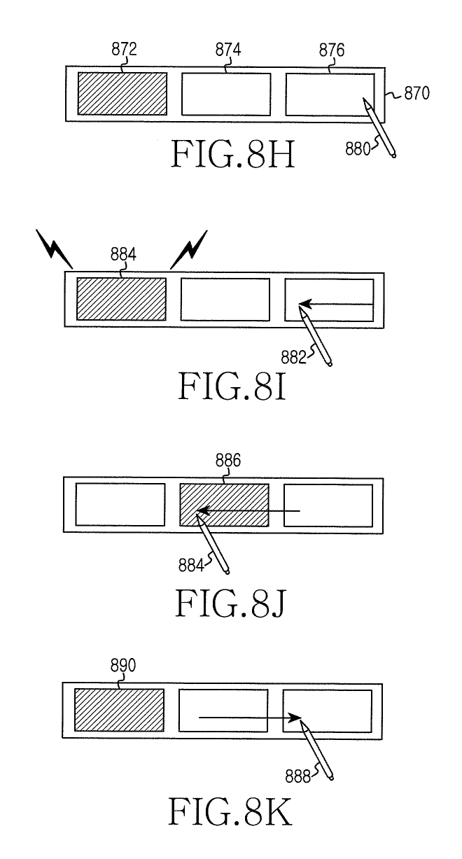

FIGS. 8A-K illustrate a screen for reproducing contents by using, a voice guidance function in an electronic device according to an exemplary embodiment of the present disclosure.

Referring to FIG. 8A, the electronic device loads contents to use the voice guidance function. For example, as shown in FIG. 8A-(a), the electronic device may load and reproduce e-book contents (801). As illustrated, text data is output in the screen with a plurality of lines.

Thereafter, the electronic device analyzes a contents reproduction screen of FIG. 8A-(a), and confirms data (e.g., text data, image data, etc.) output to the screen.

In this case, the electronic device may confirm a data arrangement pattern by analyzing a HTML tag and a code value stored in a frame buffer.

That is, the electronic device may analyze a line, a sentence start point and end point, a page, etc., of the output screen. For example, as shown in FIG. 8B, the electronic device confirms a line of a reproduction screen, and determines a guide area for each line (see 803). Herein, the guide area refers to a touch input acceptance area for data as described above.

In this case, the electronic device divides the guide area into a first guide area and a second guide area. Herein, the first guide area is an area for analyzing data in the same direction as a touch movement direction, and the second guide area is an area for analyzing data in a direction opposite to the touch movement direction.

That is, as shown in FIG. 8C, a user of the electronic device may perform touch movement in a forward direction (i.e., from the left to the right) in the first guide area, and may perform touch movement in a backward direction (i.e., from the right to the left) in the second guide area (see 810).

In this case, in the first guide area, the electronic device analyzes data in the forward direction and then outputs the data as an audio signal. In addition, in the second guide area, the electronic device analyzes data in the forward direction similarly as in the first guide area and then outputs the data as an audio signal irrespective of a user's touch movement direction (see 820).

This process is necessary so that a user input which moves in the backward direction in the second area is dealt with the same as a user input which moves in the forward direction, because it is difficult for a visually challenged user to input a first part of the second guide area.

In this case, if the user's touch input is deviated from the guide area, the electronic device generates an alarm message so that the touch movement is performed in the guide area (see 830).

FIGS. 8D-G illustrate a process of converting data of a first guide area into an audio signal according to an exemplary embodiment of the present disclosure.

Referring to FIG. 8D, it is assumed that three pieces of data 842, 844, and 846 are present in a first guide area 840.

First, as shown in FIG. 8D, when a user performs a touch input 850 on a first part of the first guide area 840, the electronic device confirms data 842 corresponding to a touch input point and converts the data 842 into an audio signal. Herein, the data converted into the audio signal is indicated by a shadowed area.

Thereafter, as shown in FIG. 8E, if the user performs a touch movement 852 from the left to the right, the electronic device outputs the converted audio signal, and then as shown in FIG. 8F, the electronic device confirms data 856 selected as a touch movement 854 occurs and converts the data into an audio signal.

As shown in FIG. 8BG, if the user performs a touch movement 858 to previously selected data, the electronic device performs a preparation process for outputting data 860 corresponding to a touch point as an audio signal.

FIGS. 8H-K illustrate a process of converting data of a second guide area into an audio signal according to an exemplary embodiment of the present disclosure.

Referring to FIG. 8H it is assumed that three pieces of data 872, 874, and 876 are present in a second guide area 870.

First, as shown in FIG. 8H, when a user performs a touch input 880 on a last part of the second guide area 870, the electronic device confirms data 872 corresponding to a first part of the second guide area 870 and converts the data in to an audio signal. Herein, the data converted into the audio signal is indicated by a shadowed area.

Thereafter, as shown in FIG. 8I, if the user performs a touch movement 882 in a backward direction (i.e., from the right to the left), the electronic device outputs the converted audio signal 884, and then as shown in FIG. 8J, the electronic device confirms data 886 selected as a touch movement 884 occurs and converts the data into an audio signal.

As shown in FIG. 8K, if the user performs a touch movement 888 to previously selected data, the electronic device confirms data 890 located in a direction opposite to a touch movement direction, and performs a preparation process for outputting the data as an audio signal.

The dividing of the guide area into the first guide area and the second guide area as illustrated in FIGS. 8D-G and FIGS. 8H-K is necessary so that a user input which moves in the backward direction in the second area is dealt with the same as a user input which moves in the forward direction, because the data is difficult for a visually challenged user to input the first part of the second guide area.

In addition, data illustrated in FIGS. 8D-G and FIGS. 8H-K may be at least one piece of character data, a word consisting of a plurality of pieces of character data, or a sentence.

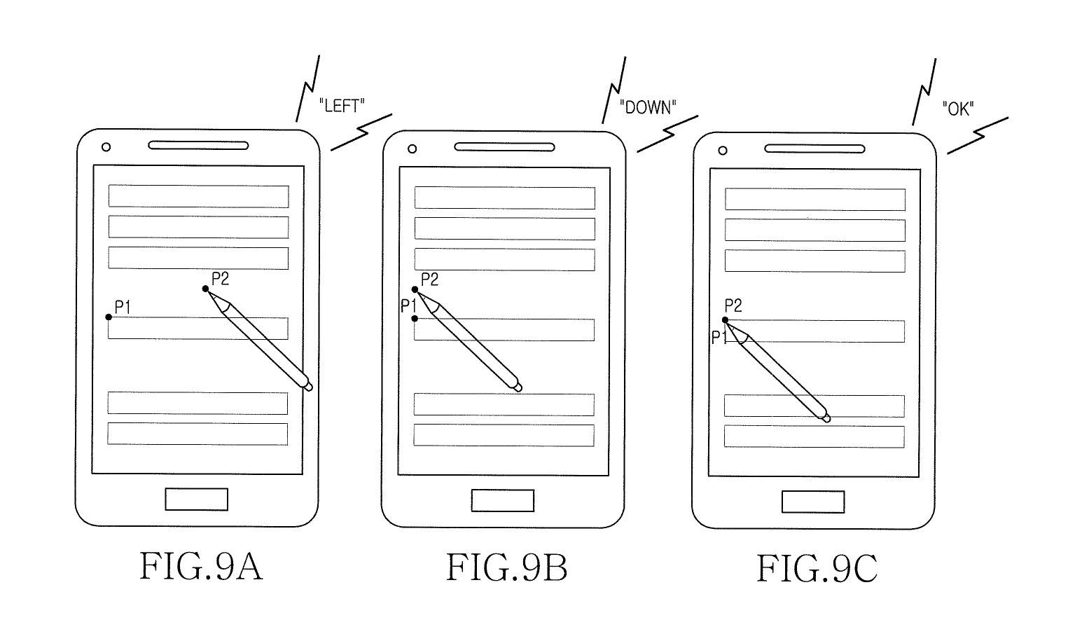

FIGS. 9A-C illustrate a screen for providing movement information for a touch input of a user in an electronic device according to an exemplary embodiment of the present disclosure.

Referring to FIG. 9A, the electronic device may confirm a contents reproducing point P1 and a touch input point P2 as shown in FIG. 9A.

Herein, the contents reproduction point may be a bookmark point, a start point of a changed line, etc.

First, the electronic device predicts a path to the contents reproduction point with respect to the touch input point, and thereafter outputs direction information for moving a touch input.

That is, the electronic device may output direction information (e.g., “Left”) as an audio signal to move the touch input of the user to the left as shown in FIG. 9A.

Upon recognizing the direction information, the user moves the current touch input to the left.

Thereafter, the electronic device persistently outputs direction information as an audio signal so that a touch input is moved to the contents reproduction point as shown in FIG. 9B. If the touch input of the user is moved to the contents reproduction point, information (e.g., “OK”) for reporting that the movement is normally complete is output as shown in FIG. 9C.

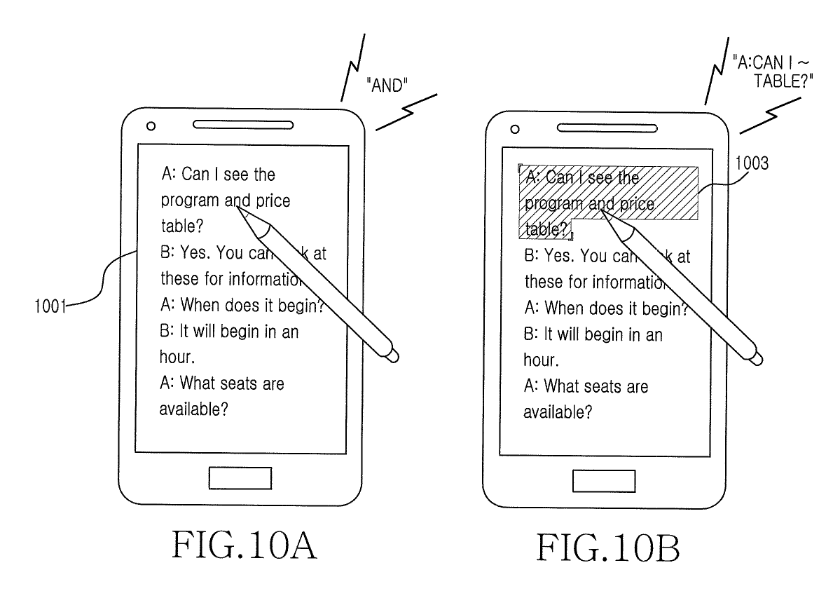

FIGS. 10A-B illustrate a screen for changing a guide area in an electronic device according to an exemplary embodiment of the present disclosure.

Referring to FIG. 10A, the electronic device reproduces contents and outputs the contents to a display unit (see 1001) as shown in FIG. 10A.

If a user performs a touch input on some parts of the output screen, the electronic device outputs data for a corresponding point by converting the data into an audio signal. That is, if a touch input occurs at a word “and” as illustrated, the electronic device outputs text data “and” by converting the data into an audio signal.

Meanwhile, the electronic device senses a pen pressure for the touch input of the user. When the pen pressure is greater than or equal to a threshold, a different operation may be performed.

For example, when the pen pressure is less than the threshold, the electronic device outputs data by converting the data into an audio signal, as described above.

For another example, when the pen pressure is greater than or equal to the threshold, the electronic device determines a guide area for a paragraph or sentence including a touch input point, and thereafter outputs data of the determined guide area by converting the data into an audio signal.

That is, as shown in FIG. 10B, the electronic device outputs data of a sentence indicated by the guide area at a pre-set speed by converting the data into an audio signal (1003).

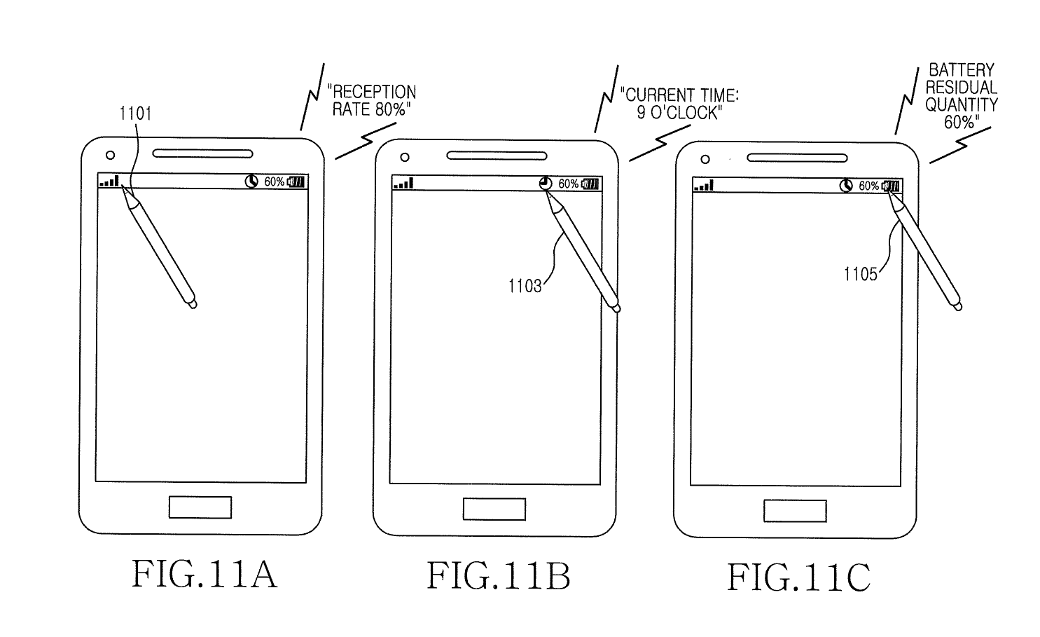

FIGS. 11A-C illustrate a screen for providing indicator information in an electronic device according to an exemplary embodiment of the present disclosure.

Referring to FIGS. 11A-C, the electronic device senses a touch input of a user with respect to an indicator icon, and outputs corresponding information as an audio signal.

That is, as shown in FIG. 11A, when a touch input 1101 for an icon (i.e., an antenna icon) indicating a reception rate is sense, the electronic device outputs information on a current reception rate by converting the information into an audio signal.

In addition, as shown in FIG. 11B, if a touch input 1103 for an icon (i.e., a clock icon) indicating a time is sensed, the electronic device outputs information on a current time by converting the information into an audio signal.

In addition, as shown in FIG. 11C, if a touch input 1105 for an icon (i.e., a battery icon) indicating battery residual quantity is sensed, the electronic device outputs information on current battery residual quantity, battery usable time, or the like by converting the information into an audio signal.

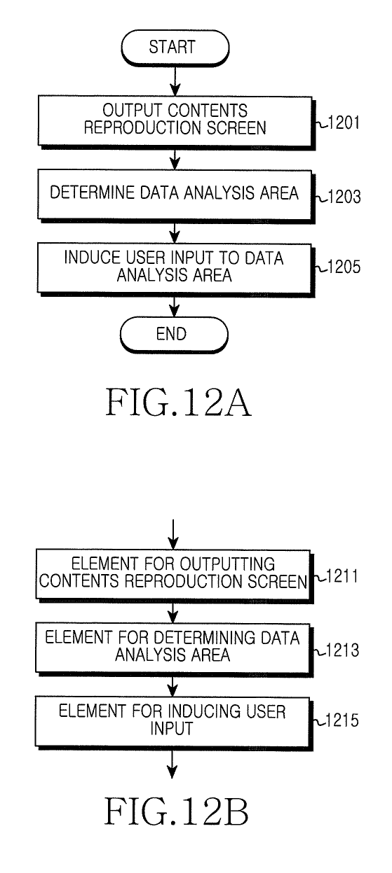

FIG. 12A is a flowchart illustrating a process of providing a voice guidance function in an electronic device according to an exemplary embodiment of the present disclosure.

Referring to FIG. 12A, the electronic device performs a step 1201 of outputting a contents reproduction screen, a step 1203 of analyzing the output reproduction screen to determine a data analysis area, and a step 1205 of inducing a user input to the data analysis area.

The step 1201 of outputting the contents reproduction screen refers to a process of reproducing contents. The step 1203 of analyzing the output reproduction screen to determine the data analysis area refers to a process of analyzing a frame buffer or an HTML Tag to confirm a data arrangement pattern.

That is, the electronic device performs the aforementioned process to confirm a line, a sentence start location, a sentence end location, a page, etc., of the output screen.

In addition, the step 1205 of inducing the user input to the data analysis area may be a process in which the electronic device determines a path of the data analysis area on the basis of the input point of the user and then outputs direction information so that an input point of the user is changed to the data analysis area.

An instruction set for each step of FIG. 12A is performed by the contents reproducing program 114 and the data converting program 115 of the memory 110 of FIG. 1.

FIG. 12B is a flowchart related to an electronic device for performing a voice guidance function according to an exemplary embodiment of the present disclosure.

First, the electronic device includes an element 1211 for outputting a contents reproduction screen, an element 1213 for analyzing the output reproduction screen to determine a data analysis area, and an element 1215 for inducing a user input to the data analysis area.

The element 1211 for outputting the contents reproduction screen performs a process of reproducing contents. The element 1203 for analyzing the output reproduction screen to determine the data analysis area performs a process of analyzing a frame buffer or an HTML Tag to confirm a data arrangement pattern.

That is, the electronic device performs the aforementioned process to confirm a line, a sentence start location, a sentence end location, a page, etc., of the output screen.

In addition, the element 1205 for inducing the user input to the data analysis area may perform a process in which the electronic device determines a path of the data analysis area on the basis of the input point of the user and then outputs direction information so that an input point of the user is changed to the data analysis area.

The aforementioned elements may be configured in separate hardware components or may be configured in one hardware component.

As described above, according to the present disclosure, the electronic device for providing data of contents to be reproduced as an audio signal analyzes a reproduction screen to determine a data analysis point, and an input of a visually challenged user can be induced to the data analysis point.

In addition, the electronic device of the present disclosure enables data analysis in a forward direction even if a user's touch input is sensed in a backward direction, thereby solving a problem in that visually challenged people cannot easily move a touch input.

It will be appreciated that embodiments of the present disclosure according to the claims and description in the specification can be realized in the form of hardware, software or a combination of hardware and software. Any such software may be stored in a non-transient computer readable storage medium. The computer readable storage medium stores one or more programs (software modules), the one or more programs comprising instructions, which when executed by one or more processors in an electronic device, cause the electronic device to perform a method of the present disclosure. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method for providing a voice guidance function in an electronic device, the method comprising:
outputting a reproduction screen of contents;
determining a data analysis area by confirming an arrangement of data constituting an output screen; and
guiding a user input to the determined data analysis area,
wherein the arrangement of data comprises at least one of a line, a line start point, a line end point, a sentence start point, a sentence end point, and a page of the output screen.

2. The method of claim 1, further comprising:
determining a first area for analyzing data in a same direction as a direction in which the user input moves;
determining a second area for analyzing data in a direction opposite to the direction in which the user input moves; and
after inducing the user input, analyzing data according to the area in which the user input is sensed and according to the input movement direction and outputting an audio signal corresponding to the analyzed data according to the area in which the user input is sensed.

3. The method of claim 1, further comprising, after guiding the user input, providing an alarm notification when the user input is deviated from the data analysis area.

4. The method of claim 1, wherein determining the data analysis area comprises:
analyzing the user input;
upon sensing a first input, determining a pre-set data analysis area; and
upon sensing a second input, extending the pre-set data analysis area.

5. The method of claim 1, further comprising outputting indicator information corresponding to a location at which the user input is sensed by converting the indicator information into an audio signal.

6. The method of claim 1, wherein guiding the user input to the determined data analysis area comprises:
determining a location of the user input relative to the determined data analysis area; and
generating an audio signal indicating a direction to reach the determined data analysis area.

7. The method of claim 6, further comprising:
in response to determining that the user input has reached the determined data analysis area, generating an audio signal indicating that the user input has reached the determined data analysis area.

8. An apparatus for providing voice guidance function in an electronic device, the apparatus comprising:
at least one processor;
a memory storing at least one program stored in the memory and configured to be executable by the at least one processor, wherein the apparatus is configured to:
output a reproduction screen of contents,
determine a data analysis area by confirming an arrangement of data constituting an output screen, and
induce a user input to the determined data analysis area,
wherein the data arrangement comprises at least one of a line, a line start point, a line end point, a sentence start point, a sentence end point, and a page of the output screen.

9. The apparatus of claim 8, further configured to:
determine a first area for analyzing data in a same direction as a direction in which the user input moves,
determine a second area for analyzing data in a direction opposite to the direction in which the user input moves, and
after inducing the user input, analyze data according to the area in which the user input is sensed and according to the input movement direction and output an audio signal corresponding to the analyzed data according to the area in which the user input is sensed.

10. The apparatus of claim 8, further configured to, after inducing the user input, provide an alarm notification when the user input is deviated from the data analysis area.

11. The apparatus of claim 8, wherein in determining the data analysis area, the apparatus is further configured to:
analyze the user input;
upon sensing a first input, determine a pre-set data analysis area; and
upon sensing a second input, extend the pre-set data analysis area.

12. The apparatus of claim 8, further configured to output indicator information corresponding to a location at which the user input is sensed by converting the indicator information into an audio signal.

13. The apparatus of claim 8, wherein in guiding the user input to the determined data analysis area, the apparatus is further configured to:
determine a location of the user input relative to the determined data analysis area; and
generate an audio signal indicating a direction to reach the determined data analysis area.

14. The apparatus of claim 8, further configured to in response to determining that the user input has reached the determined data analysis area, generate an audio signal indicating that the user input has reached the determined data analysis area.

15. A computer-readable storage medium tangibly embodying one or more programs, the one or more programs comprising program code for:
outputting a reproduction screen of contents;
determining a data analysis area by confirming an arrangement of data constituting an output screen; and
guiding a user input to the determined data analysis area,
wherein the arrangement of data comprises at least one of a line, a line start point, a line end point, a sentence start point, a sentence end point, and a page of the output screen.

16. The computer-readable storage medium of claim 15, further comprising program code for:
determining a first area for analyzing data in a same direction as a direction in which the user input moves;
determining a second area for analyzing data in a direction opposite to the direction in which the user input moves; and
after inducing the user input, analyzing data according to the area in which the user input is sensed and according to the input movement direction and outputting an audio signal corresponding to the analyzed data according to the area in which the user input is sensed.

17. The computer-readable storage medium of claim 15, further comprising program code for, after guiding the user input, providing an alarm notification when the user input is deviated from the data analysis area.

18. The computer-readable storage medium of claim 15, wherein the program code for determining the data analysis area comprises program code for:
analyzing the user input;
upon sensing a first input, determining a pre-set data analysis area; and
upon sensing a second input, extending the pre-set data analysis area.

19. The computer-readable storage medium of claim 15, further comprising program code for outputting indicator information corresponding to a location at which the user input is sensed by converting the indicator information into an audio signal.

20. The computer-readable storage medium of claim 15, wherein the program code for guiding the user input to the determined data analysis area comprises program code for:
determining a location of the user input relative to the determined data analysis area; and
generating an audio signal indicating a direction to reach the determined data analysis area.
